(19) United States
(12) Patent Application Publication
(10) Pub. No.: US 2018/0171688 A1
(43) Pub. Date: Jun. 21, 2018

(54) KNOB TO LATCH INTERFACE, METHOD OF INTERFACING A KNOB TO A ROTATABLE LATCH

(71) Applicant: Sikorsky Aircraft Corporation, Stratford, CT (US)

(72) Inventor: Lance Halcom, Coppell, TX (US)

(21) Appl. No.: 15/579,069

(22) PCT Filed: Apr. 8, 2016
(86) PCT No.: PCT/US2016/026560

§ 371 Date: Dec. 1, 2017

Related U.S. Application Data
(60) Provisional application No. 62/173,092, filed on Jun. 9, 2015.

(51) Int. Cl. E05C 3/16; E05C 19/02; E05B 41/00; E05B 5/02; E05C 3/04

(52) U.S. Cl. CPC E05C 3/162; E05C 19/022; E05C 3/167; B64C 27/04; E05B 5/003; E05C 3/041; E05B 41/00

(57) ABSTRACT

According to one embodiment of the disclosure, a knob to latch interface includes a body, a latch in operable communication with the body movable between a latched position and an unlatched position, and a knob longitudinally positionable between a first position and a second position relative to the body and in operable communication with the latch, an outer radial extent of the knob being operationally engagable only while in one of the first position and the second position.

### FEDERAL RESEARCH STATEMENT

This invention was made with government support under W911W6-13-2-0003 awarded by the US Army. The government has certain rights in the invention.

### BACKGROUND

The subject matter disclosed herein relates to an interface between a knob and a rotatable latch, more particularly, to a positionable knob that is operationally engagable when in one of two positions and is not engagable when in the other of the two positions.

Rotatable latches are usable for latching various parts to one another. Such latches can be rotated by rotation of a knob in operable communication with the latch. Unlatching is typically performed by rotating the knob in a direction opposite to the direction that causes the latch to become latched. Alterations to latching systems that provide visual feedback that indicates a latch may not be latched are of interest to those who practice in the art.

### BRIEF DESCRIPTION

According to one embodiment of the disclosure, a knob to latch interface includes a body, a latch in operable communication with the body movable between a latched position and an unlatched position, and a knob longitudinally positionable between a first position and a second position relative to the body and in operable communication with the latch, an outer radial extent of the knob is operationally engagable only while in one of the first position and the second position.

In addition to one or more of the features described above, or as an alternative, in further embodiments the outer radial extent is configured to be engagable by a tool to cause rotation of the knob.

In addition to one or more of the features described above, or as an alternative, in further embodiments a biasing member urges the knob toward the first position.

In addition to one or more of the features described above, or as an alternative, in further embodiments a sleeve is in operable communication with the knob and the body thereby allowing the knob to latch interface to maintain the knob alternately in the first position and the second position in response to longitudinal movements of the knob.

In addition to one or more of the features described above, or as an alternative, in further embodiments at least one wing in operable communication with the knob that is engagable with a recess in the sleeve that defines longitudinal travel limits of the knob.

In addition to one or more of the features described above, or as an alternative, in further embodiments the recess is formed in an inner radial surface of the sleeve.

In addition to one or more of the features described above, or as an alternative, in further embodiments the knob is prevented from being moved to the second position when the latch is not in the latched position.

In addition to one or more of the features described above, or as an alternative, in further embodiments the latch is prevented from being moved from the latched position while the knob is in the second position.

In addition to one or more of the features described above, or as an alternative, in further embodiments the knob while in the first position provides a visual cue that the latch may not be latched.

In addition to one or more of the features described above, or as an alternative, in further embodiments the latch holds a fairing to an aircraft.

According to one embodiment of the disclosure, a method of interfacing a knob to a rotatable latch, includes rotationally locking a knob to a latch, repeatedly longitudinally urging and releasing the knob in a first direction against a bias, longitudinally moving the knob in a second direction with the bias upon release of the longitudinal urging, alternately moving the knob between a first position and a second position, an outer radial extent of the knob is engagable to rotate the knob when the knob is in the first position and not engagable when the knob is in the second position.

In addition to one or more of the features described above, or as an alternative, in further embodiments positioning the outer radial extent of the knob below or within a surface in the second position.

According to one embodiment of the disclosure, an aircraft, including a rotor hub, and at least one fairing latched to the rotor hub by the knob to latch interface described above.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a side cross sectional view of a knob to latch interface in a first position;

FIG. 2 is a side cross sectional view of the knob to latch interface of FIG. 1 in a second position;

FIG. 3 is perspective view of a knob used in the interface of FIG. 1;

FIG. 4 is a perspective view of a follower used in the interface of FIG. 1;

FIG. 5 is a perspective view of a sleeve used in the interface of FIG. 1;

FIG. 6 is a perspective view of a housing used in the interface of FIG. 1; and

FIG. 7 is a side view of an aircraft employing the interface of FIG. 1.

### DETAILED DESCRIPTION

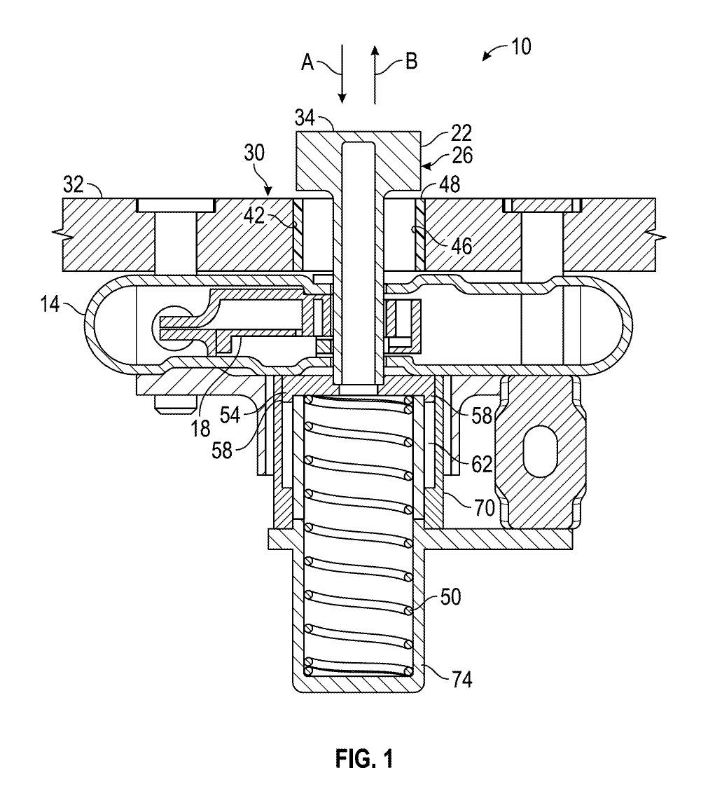

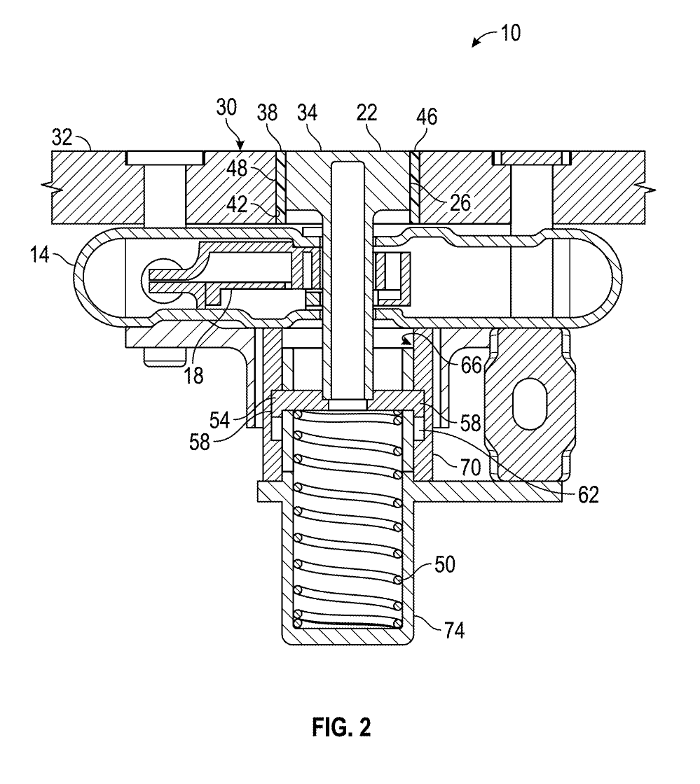

Referring to FIGS. 1 and 2, a knob to latch interface 10 for controlling a rotatable latch position is illustrated in cross section. The knob to latch interface 10 includes a body 14, a latch 18 and a knob 22. The latch 18 and the knob 22 rotationally interface the body 14. The latch 18 is rotationally movable via rotation of the knob 22 at least between a latched position and an unlatched position. In the latched position a member (not shown) can be held positionally relative to the body 14 by the latch 18. Conversely, the member is not held when the latch 18 is in the unlatched position. The knob 22 is longitudinally positionable between a first position relative to the body as shown in FIG. 1 and a second position as shown in FIG. 2.

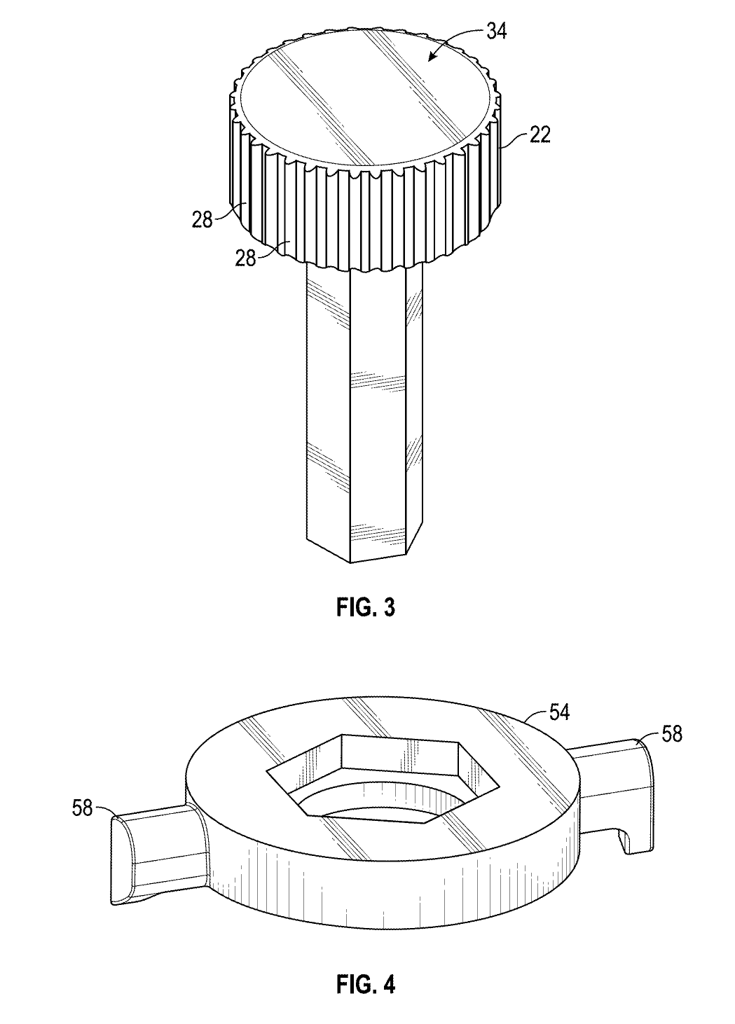

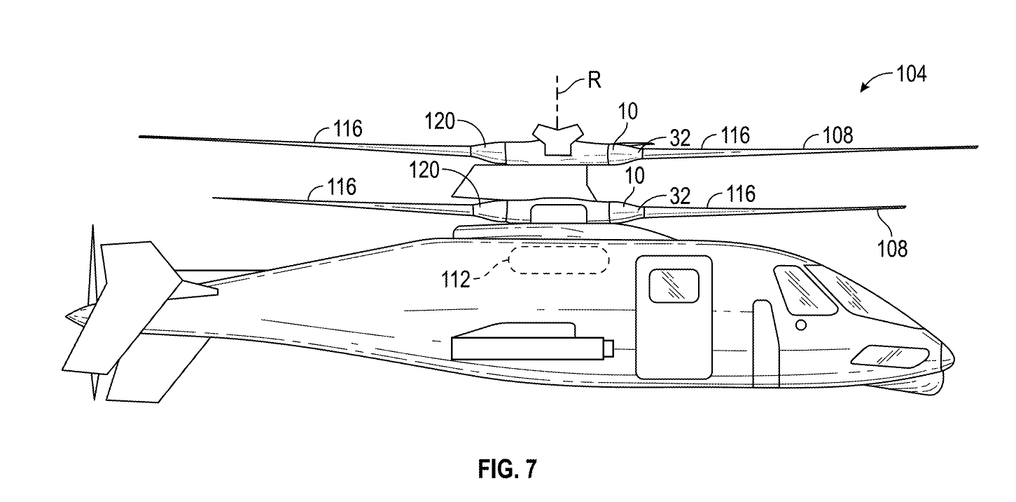

The knob 22 has a an outer radial extent 26, which in this particular embodiment includes ribs 28 (FIG. 3), that are engagable by a tool (not shown) such as a pair of plyers or even a person's hand while in the first position to allow rotation of the knob 22 relative to the body 14. When in the second position the outer radial extent 26 is sunk below a surface 30 of a member 32 (FIG. 2), such as a fairing or shell, for example, thereby preventing radial engagement with the outer radial extent 26. An end 34 of the knob 22 can be aligned substantially flush with the surface 30 when the knob 22 is in the second position. A small annular gap 38 between the outer radial extent 26 and an inner radial surface 42 of an opening 46 in the surface 30 can occlude entry of contamination or airflow therethrough. Both the flush nature and the small annular gap 38 can improve aerodynamics of a vehicle, such as an aircraft 104 (FIG. 7), for example, employing the knob to latch interface 10. Embodiments can optionally include a seal 48 to fill the gap 38. The seal 48 can improve aerodynamics further and reduce noise associated with air flow over the gap 38 if the seal 48 were not present.

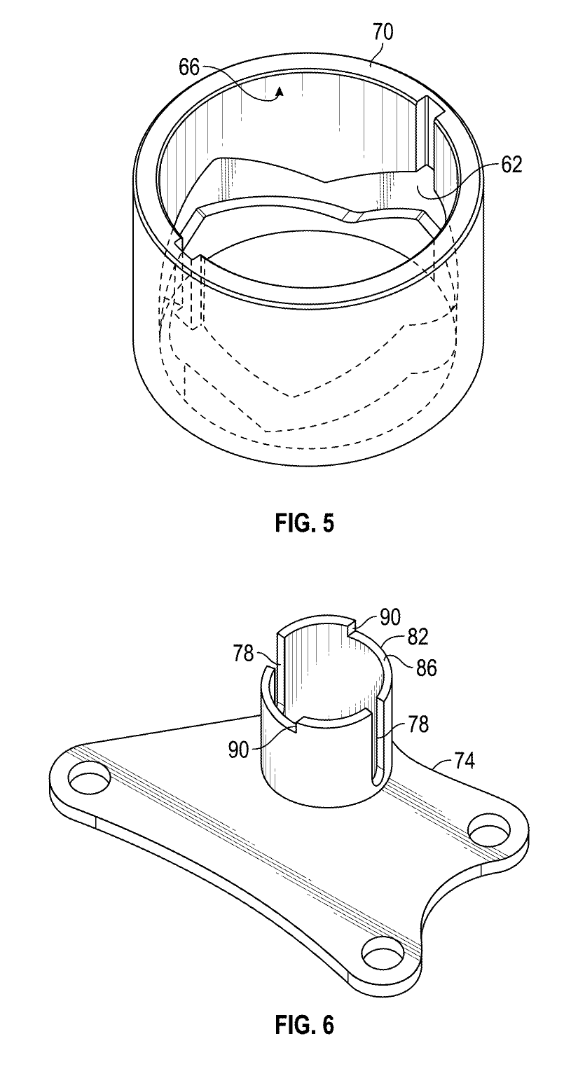

The knob 22 is alternately positionable between the first position and the second position by longitudinally moving the knob 22 in a first direction designated by arrow “A” and a second direction designated by arrow “B” (arrows shown in FIG. 1 only). A biasing member 50, illustrated herein as a compression spring, biases the knob 22 in the second direction. A follower 54 (best illustrated in FIG. 4), is rotationally locked to the knob 22 and has wings 58 that engage with a recess 62 formed in an inner radial surface 66 of a sleeve 70 (best illustrated in FIG. 5), that is free to rotate relative to the body 14. The knob 22 is also rotationally locked to the latch 18 by a hexagonal or other shaped portion of the knob 22 that extends through a complementary shaped portion of the latch 18 that allows longitudinal movement therebetween. In alternate embodiments the latch 18 can be rotationally locked to the follower 54, or similar piece, instead of being rotationally locked to the knob 22 directly. Doing so might also include the knob 22 being rotationally locked to the follower 54, or similar piece, while allowing longitudinal movement therebetween. Interaction of the foregoing components cause the knob 22 to move alternately between the first position and the second position in a manner similar to a retractable pen in response to repeatedly pushing against the end 34 in the first direction and then releasing. The wings 58 engagement within the recess 62 cause the sleeve 70 to rotate as the knob 22 moves cyclically between the first position and the second position.

A housing 74 (FIG. 6) is attached to the body 14 and abuts an end of the biasing member 50 opposite the follower 54. Slots 78 on a tubular portion 82 of the housing 74 maintain rotational alignment of the follower 54 and the knob 22 when the knob 22 is in the second position or part way between the first position and the second position. When the knob 22 is in the first position the wings 58 are allowed to rotate along an end 86 of the tubular portion 82 until they abut shoulders 90 that prevent additional rotational motion of the knob 22. Since the follower 54 can only be moved in the first direction when the wings 58 are aligned with the slots 78, and the slots 78 are sized perimetrically only a little larger than a width of the wings 58, the knob 22 is prevented from being moved to the second position at all rotational positions other than the rotational position that causes alignment between the wings 58 and the slots 78. This rotational position is selected in one embodiment to coincide with the latch 18 being in a fully latched position. As such, the knob 22 cannot be moved to the second position unless the latch 18 is fully latched. The knob 22 being positioned in the first position provides a visual cue to an operator that the latch 18 may not be fully latched. Additionally, the knob 22, and thus the latch 18, cannot be rotated while the knob 22 in the second position or between the first position and the second position, thereby preventing moving the latch 18 to the unlatched position unless the knob 22 is in the first position.

The foregoing structure allows for a method of interfacing the knob 22 to a rotatable latch 18. The method includes rotationally locking the knob 22 to the latch 18, repeatedly longitudinally urging and releasing the knob 22 in a first direction against a bias, and longitudinally moving the knob 22 in a second direction with the bias upon release of the longitudinal urging. Additionally the method includes alternately moving the knob 22 between a first position and a second position, the outer radial extent 26 of the knob 22 being engagable to rotate the knob 22 when the knob 22 is in the first position and not engagable when the knob 22 is in the second position. The method may also include positioning the outer radial extent 26 of the knob 22 below or within the surface 30 when in the second position. The structure also allows for preventing movement of the knob 22 from the first position to the second position when the latch 18 is not in a latched position.

Referring to FIG. 7, an aircraft 104 using the knob to latch interface 10 according to one embodiment disclosed herein. The Figure schematically illustrates an exemplary vertical takeoff and landing (VTOL) rotary-wing aircraft 104. The aircraft 104 in this non-limiting embodiment includes two main rotor assemblies 108. The main rotor assemblies 108 are driven about a rotor axis of rotation R through a main rotor gearbox MGB by one or more engines 112. The main rotor assemblies 108 include multiple rotor blade assemblies 116 mounted to a rotor hub 120. The knob to latch interface 10 is part of the rotor hub 120. Each of the fairings 32 is latched to the rotor hub 120 by one of the knob to latch interfaces 10. Fairing 32 covers the rotor hub 120 thereby improving aerodynamics of the aircraft 104. Although a particular helicopter configuration is illustrated and described in this exemplary embodiment, other configurations and/or machines, such as high speed compound rotary wing aircraft with supplemental translational thrust systems, turbo-props, tilt-rotors and tilt-wing aircraft, will also benefit from the present embodiments.

While embodiments of the interface 10 have been illustrated as latching the fairing 32 to the aircraft 104, it should be noted that in alternate embodiments the interface 10 could be employed to latch items other than the fairing 32, such as, doors and removable panels, for example. Additionally, the interface 10 could be employed in applications not related to an aircraft, such as automobiles and motorcycles as well as in non-moving applications. Alternate applications may benefit from aesthetic improvements when the aerodynamic and failsafe aspects of the interface 10 are not of particular importance or interest, for example.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in spirit and/or scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

1. A knob to latch interface, comprising:
a body;
a latch in operable communication with the body movable between a latched position and an unlatched position; and
a knob longitudinally positionable between a first position and a second position relative to the body being in operable communication with the latch, an outer radial extent of the knob being operationally engagable only while in one of the first position and the second position.

2. The knob to latch interface of claim 1, wherein the outer radial extent is configured to be engagable by a tool to cause rotation of the knob.

3. The knob to latch interface of claim 1, further comprising a biasing member that urges the knob toward the first position.

4. The knob to latch interface of claim 1, further comprising a sleeve in operable communication with the knob and the body thereby allowing the knob to latch interface to maintain the knob alternately in the first position and the second position in response to longitudinal movements of the knob.

5. The knob to latch interface of claim 1, further comprising at least one wing in operable communication with the knob that is engagable with a recess in the sleeve that defines longitudinal travel limits of the knob.

6. The knob to latch interface of claim 5, wherein the recess is formed in an inner radial surface of the sleeve.

7. The knob to latch interface of claim 1, wherein the knob is prevented from being moved to the second position when the latch is not in the latched position.

8. The knob to latch interface of claim 1, wherein the latch is prevented from being moved from the latched position while the knob is in the second position.

9. The knob to latch interface of claim 1, wherein the knob being in the first position provides a visual cue that the latch may not be latched.

10. The knob to latch interface of claim 1, wherein the latch holds a fairing to an aircraft.

11. The knob to latch interface of claim 1, further comprising:
a member in operable communication with the body having a surface with an opening therein, the knob having an end that is substantially aligned with the surface when in the second position and the end extending beyond the surface when in the first position.

12. A method of interfacing a knob to a rotatable latch, comprising:
rotationally locking a knob to a latch;
repeatedly longitudinally urging and releasing the knob in a first direction against a bias;
longitudinally moving the knob in a second direction with the bias upon release of the longitudinal urging; and
alternately moving the knob between a first position and a second position, an outer radial extent of the knob being engagable to rotate the knob when the knob is in the first position and not engagable when the knob is in the second position.

13. The method of interfacing a knob to a rotatable latch of claim 12, further comprising positioning the outer radial extent of the knob below or within a surface in the second position.

14. The method of interfacing a knob to a rotatable latch of claim 12, further comprising preventing movement of the knob from the first position to the second position when the latch is not in a latched position.

15. An aircraft, comprising:
a rotor hub; and
at least one fairing latched to the rotor hub by a knob to latch interface, the knob to latch interface including:
a body;
a latch in operable communication with the body movable between a latched position and an unlatched position; and
a knob longitudinally positionable between a first position and a second position relative to the body being in operable communication with the latch, an outer radial extent of the knob being operationally engagable only while in one of the first position and the second position.
